(19) United States
(12) Patent Application Publication
(10) Pub. No.: US 2015/0330249 A1
(43) Pub. Date: Nov. 19, 2015

(54) FRAME STRUT COOLING HOLES

(71) Applicant: UNITED TECHNOLOGIES CORPORATION, Hartford, CT (US)

(72) Inventor: Matthew BUDNICK, Hudson, NH (US)

(21) Appl. No.: 14/652,707

(22) PCT Filed: Dec. 23, 2013
(86) PCT No.: PCT/US2013/077399

§ 371 Date: Jun. 16, 2015

Related U.S. Application Data
(60) Provisional application No. 61/747,273, filed on Dec. 29, 2012.

(51) Int. Cl. F01D 25/14; F01D 25/28; F01D 25/12

(52) U.S. Cl. CPC F01D 25/14; F01D 25/12; F01D 25/28; F05D 2220/32; F05D 2260/202

(57) ABSTRACT

A module for a gas turbine engine comprises a frame and a frame cooling system. The frame includes a circumferentially distributed plurality of radially extending struts. Each strut is joined to an outer frame section at an outer frame junction, and joined to an inner frame section at an inner frame junction. The frame cooling system comprises an inlet, a plurality of cooling air passages extending from the inlet radially through each of the plurality of frame struts, and an outlet. The outlet is in fluid communication with at least one of the cooling air passages and includes a plurality of film cooling holes formed through a circumferentially facing wall of each strut at a location distal from the outer frame junction.

### BACKGROUND

The described subject matter relates generally to gas turbine engines, and more specifically to cases and frames for gas turbine engines.

Gas turbine engines operate according to a continuous-flow, Brayton cycle. A compressor section pressurizes an ambient air stream, fuel is added and the mixture is burned in a central combustor section. The combustion products expand through a turbine section where bladed rotors convert thermal energy from the combustion products into mechanical energy for rotating one or more centrally mounted shafts. The shafts, in turn, drive the forward compressor section, thus continuing the cycle. Gas turbine engines are compact and powerful power plants, making them suitable for powering aircraft, heavy equipment, ships and electrical power generators. In power generating applications, the combustion products can also drive a separate power turbine attached to an electrical generator.

Gas turbine engines are supported by frames which typically include one or more struts. The struts connect outer and inner cases and cross a flow passage carrying working gases such as combustion products. Due to the need for the struts to retain their strength at high temperatures, frames used on the turbine side of the engine have been produced using investment cast superalloys. However, casting of superalloys becomes more difficult and expensive as the radial dimension of the frame increases. As such, a need has been recognized for reducing the temperature of the frame without sacrificing the efficiency gains seen with higher combustion temperatures.

### SUMMARY

A module for a gas turbine engine comprises a frame and a fame cooling system. The frame includes a circumferentially distributed plurality of radially extending struts. Each strut is joined to an outer frame section at an outer frame junction, and joined to an inner frame section at an inner frame junction. The frame cooling system comprises an inlet, a plurality of cooling air passages extending from the inlet radially through each of the plurality of frame struts, and an outlet. The outlet is in fluid communication with at least one of the cooling air passages and includes a plurality of film cooling holes formed through a circumferentially facing wall of each strut at a location distal from the outer frame junction.

A gas turbine engine frame comprises an outer case, an inner hub, and a strut extending radially between the inner hub and the outer case. The strut is joined to the outer case at an outer frame junction, and is joined to the inner case at the inner frame junction. A cooling system includes an inlet, a cooling air passage extending from the inlet radially through the strut, and an outlet in fluid communication with the cooling air passage. The outlet includes at least one film cooling hole formed through a circumferentially facing wall of each strut at a location distal from a junction of the strut and the outer case.

### BRIEF DESCRIPTION OF THE DRAWINGS

FIG. 1 schematically depicts a cross-section of a gas turbine engine.

FIG. 2A shows a detailed cross-section of a turbine assembly, including a first turbine section and a second turbine section interconnected by a module with a frame cooling system.

FIG. 2B is a detailed plan view of a portion of the module shown in FIG. 2A.

FIG. 2C shows an axial section view taken across line 2C-2C of FIG. 2A.

FIG. 3A isometrically depicts a forward side of an example frame incorporating a frame cooling system.

FIG. 3B isometrically depicts an aft side of the frame shown in FIG. 3A.

FIG. 4 is a detailed view of a portion of the frame shown in FIG. 3B.

FIG. 5 shows a radial cross-section taken through line 5-5 of FIG. 3A

FIG. 6A shows an outlet with a first arrangement of cooling holes aligned along an outer frame junction.

FIG. 6B shows an outlet with a second arrangement of cooling holes aligned along the outer frame junction.

FIG. 6C shows an outlet with a third arrangement of cooling holes disposed proximate the outer frame junction and axially aligned with the engine center line.

FIG. 6D shows an outlet with a fourth arrangement of cooling holes disposed proximate the outer frame junction and axially staggered relative to the engine center line.

FIG. 7A shows a fifth arrangement of cooling holes radially aligned along a circumferentially facing strut wall.

FIG. 7B shows a sixth arrangement of cooling holes radially aligned along a circumferentially facing strut wall.

FIG. 7C shows a seventh arrangement of cooling holes radially aligned along a circumferentially facing strut wall.

FIG. 7D shows an eighth arrangement of cooling holes disposed on a circumferentially facing strut wall and radially staggered relative to the length of the strut.

### DETAILED DESCRIPTION

Strut cooling holes can be used to provide additional surface cooling of a gas turbine frame, particularly in and around the circumferential walls of one or more frame struts. The cooling air passage(s) as well as the count, size, direction, and angles of strut cooling holes can be tailored to help lower frame surface temperatures, enabling the use of less costly materials that are easier to process than superalloys traditionally used in gas turbine frames. In addition, strut cooling holes can be used to help control the balance of cooling air between inner and outer portions of the frame, thereby maintaining an appropriate thermal differential which reduces thermal stresses across the struts.

It will be recognized that like numbers refer to similar structures throughout the figures.

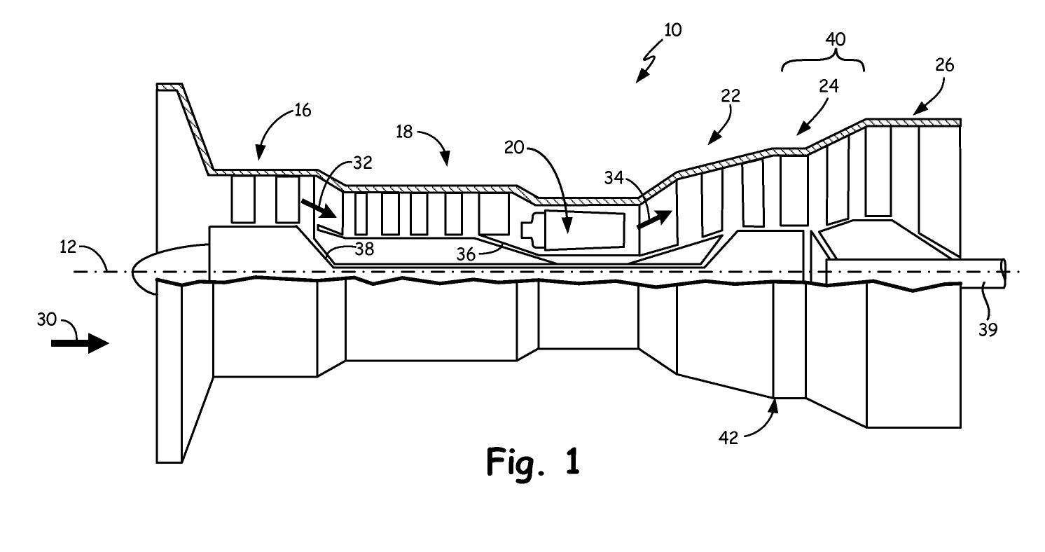

FIG. 1 shows industrial gas turbine engine 10, one example of a gas turbine engine. Engine 10 is circumferentially disposed about a central, longitudinal axis, or engine centerline axis 12, and includes in series order, low pressure compressor section 16, high pressure compressor section 18, combustor section 20, high pressure turbine section 22, and low pressure turbine section 24. In some examples, a free turbine section 26 is disposed aft of the low pressure turbine 24. Free turbine section 26 is often described as a “power turbine” and may rotationally drive one or more generators, centrifugal pumps, or other apparatus.

As is well known in the art of gas turbines, incoming ambient air 30 becomes pressurized air 32 in compressors 16, 18. Fuel mixes with pressurized air 32 in combustor section 20, where it is burned. Once burned, combustion gases 34 expand through turbine sections 22, 24 and power turbine 26. Turbine sections 22 and 24 drive high and low pressure rotor shafts 36 and 38 respectively, which rotate in response to the combustion products and thus the attached compressor sections 18, 16. Free turbine section 26 may, for example, drive an electrical generator, pump, or gearbox (not shown) via power turbine shaft 39.

FIG. 1 also shows turbine assembly 40, which includes two turbine modules interconnected by turbine exhaust case (TEC) assembly 42. Here, turbine assembly 40 can include turbine exhaust case TEC assembly 42 disposed axially between low pressure turbine section 24 and power turbine 26.

FIG. 1 provides a basic understanding and overview of the various sections and the basic operation of an industrial gas turbine engine. Although illustrated with reference to an industrial gas turbine engine, the described subject matter also extends to aero engines having a fan with or without a fan speed reduction gearbox, as well as those engines with more or fewer sections than illustrated. It will become apparent to those skilled in the art that the present application is applicable to all types of gas turbine engines, including those in aerospace applications. In this example, the subject matter is described with respect to TEC assembly 42 between turbine sections 24, 26 configured in a sequential flow arrangement for an industrial gas turbine engine. However, it will be appreciated that the teachings can be readily adapted to other turbine applications with fluidly coupled modules, such as but not limited to a mid-turbine frame, an interstage turbine frame, and/or a turbine exhaust case for an aircraft engine. In other alternative embodiments, TEC assembly 42 can be adapted into a case assembly or module for portions of compressor sections 16 and/or 18.

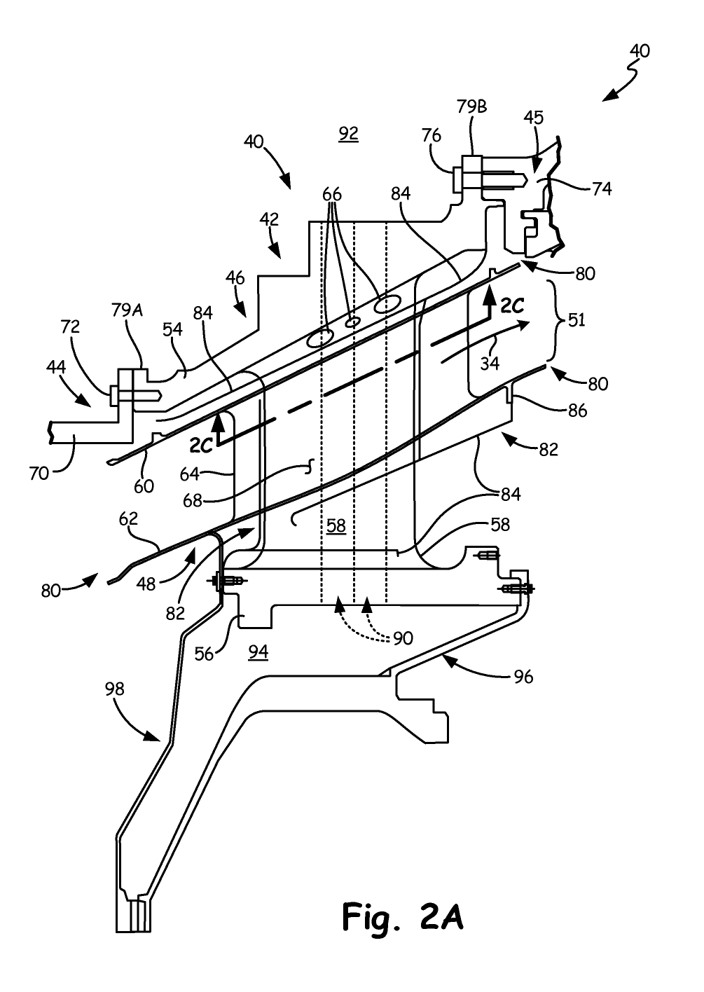

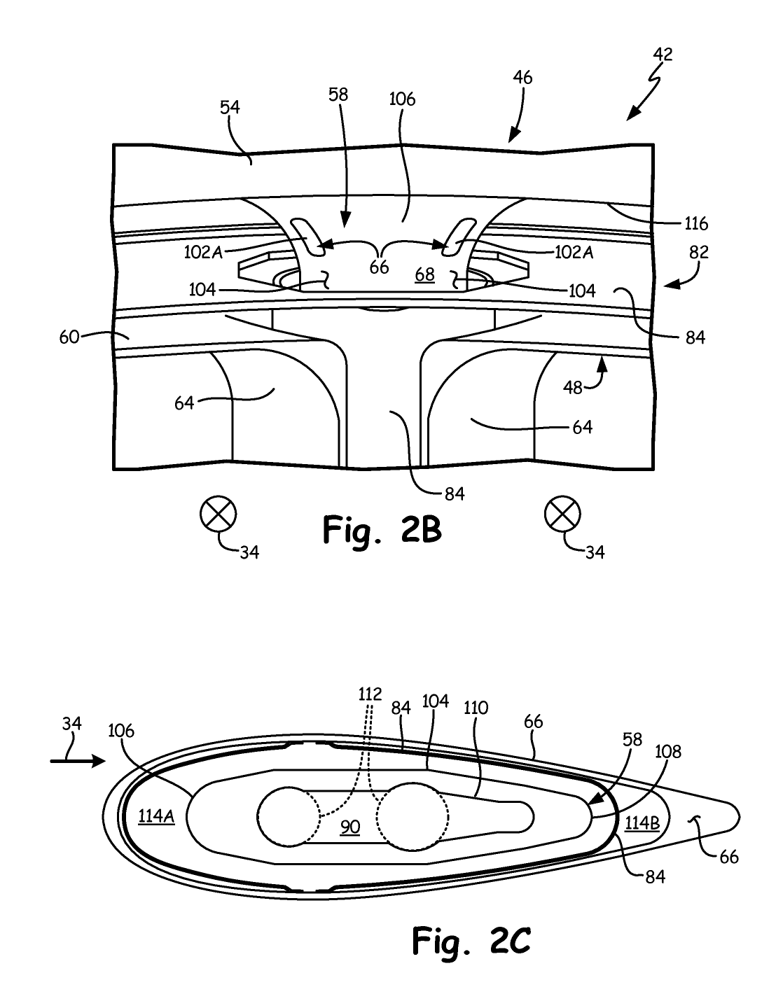

FIG. 2 shows turbine assembly 40 with TEC assembly 42. TEC assembly 42 interconnects an upstream turbine module 44 (partially shown) such as a low-pressure turbine module, with a downstream turbine module 45 (partially shown) such as a power turbine module. As was shown in FIG. 1, low-pressure turbine 24 drives a first shaft (low-pressure shaft 38), while power turbine 26 drives a second shaft (power turbine shaft 39) independently of the first shaft.

As seen in FIG. 2, TEC assembly 42 includes frame 46 and fairing assembly 48. Fairing assembly 48 defines main gas flow passage 51 for working/combustion gases 34 to flow generally axially through frame 46 during engine operation. In a conventional industrial gas turbine (IGT) system, upstream module 44 (e.g., low-pressure turbine 24 shown in FIG. 1) can include other components (not shown) such as a rotor blade and/or exit guide vane. These other components are disposed upstream of frame 46 and fairing assembly 48 with respect to a conventional flow direction of working gases 34. Downstream module 45 (e.g., power turbine 26 shown in FIG. 1) can also include other components (not shown) such as an inlet guide vane and/or rotor blade. These other components are disposed downstream of TEC assembly frame 46 and fairing assembly 48 with respect to the flow direction of working gases 34.

Frame 46 includes outer case 54, inner hub 56, and a circumferentially distributed plurality of struts 58 (only one shown in FIG. 2). Struts 58 extend radially between outer case 54 and inner hub 56. Struts 58 can be joined to outer case 54 and inner case 56 by casting, forging, welding, or other bonding processes. In certain embodiments, frame 46 is formed from a single casting comprising precursors to outer case 54, inner case 56, and struts 58.

In the embodiment shown, fairing assembly 48, which includes outer fairing platform 60, inner fairing platform 62, and strut liners 64, is secured over annular surfaces of frame 46. Outer fairing platform 60 and inner fairing platform 62 each have a generally conical shape. Inner fairing platform 62 is spaced from outer platform 60 by strut liners 64. In this example, outer fairing platform 60 is disposed radially inward of outer case 54, while inner fairing platform 62 may be disposed radially outward of inner frame hub 56. Strut liners 64 can also be disposed over frame struts 58. When assembled, outer fairing platform 60, inner fairing platform 62, and fairing strut liners 64 define a portion of main gas flow passage 51.

During operation, frame 46 is exposed to the heat of working gases 34 flowing through main gas flow passage 51. To control the temperature of frame 46 and enable the use of lower temperature materials, frame 46 can include a frame cooling system. The frame cooling system can comprise an inlet, an outlet, and a cooling air passage extending radially through one or more struts 58. In FIG. 2A, cooling air outlet 66 is visible on one strut circumferential wall 68. Additional details and examples of various inlets, outlets, and cooling air passages are described in more detail throughout this specification.

As noted above, TEC assembly 42 can interconnect adjacent turbine modules 44, 45 by way of frame outer case 54. Upstream (first) turbine module 44 includes outer case 70 connected to a forward side of TEC frame outer case 54 via fasteners 72, while downstream (second) turbine module 45 includes outer case 74 connected to an aft side of TEC frame outer case 54 via fasteners 76. TEC frame outer case 54 similarly includes forward flange 79A and aft flange 79B. TEC assembly 42 includes aft casing flange 79A and forward casing flange 79B for interconnecting TEC assembly 42 with other modules into engine 10 (shown in FIG. 1).

In addition, main gas flow passage 51 can be sealed around these and other interconnections to prevent leakage and unwanted heating of frame 42. In one example, seals (not shown) are located around the edges 80 of fairing assembly 48. One or more of these seals may be part of a larger seal assembly adapted to perform multiple sealing and support functions while helping to direct secondary air flow in and around frame 46.

To further prevent excess heating of frame 46, TEC assembly 42 also can include heat shield assembly 82 comprising one or more heat shield segments 84. Heat shield assembly 82 reduces radiative heating of frame 46 by reflecting thermal radiation back toward fairing assembly 48 and away from annular surfaces of frame 46. Heat shield segments 84 are arranged in lines of sight between fairing assembly 48 and frame 46, but are not secured directly to the hottest portions of fairing assembly 48 designed to be exposed to working gas flow 34. Rather, heat shield segments 84 can be secured to cooler portions of TEC assembly 42 such as frame 46 or external fairing flanges 86 as shown in FIG. 2.

Frame 46 can also include one or more passages 90 (shown in phantom) formed radially through struts 58. To further reduce temperature of frame 46, at least one passage 90 can carry cooling air between outer cavity 92 and inner cavity 94. Inner cavity 94 is disposed radially inward of inner hub 56, and is defined by inner hub 56, bearing support 96, and outer flow divider wall 98. As such, passages 90 may additionally and/or alternatively carry oil or buffer air service lines (not shown in FIG. 2) which continue through both inner cavity 94 and bearing support 96 into a bearing compartment (not shown).

FIG. 2B is a detailed aft-facing view of a portion of TEC assembly 42. FIG. 2C shows a sectional view of TEC assembly 42 taken across line 2C-2C of FIG. 2A. FIGS. 2B and 2C show features of TEC assembly 42 and frame 46 which allow for substitution of lower temperature materials and manufacturing processes in place of more expensive temperature-resistant materials, such as investment cast nickel-based superalloys.

As seen in FIG. 2B, strut 58 can be provided with cooling air outlets 66 on either circumferential wall 68 to reduce surface temperatures of frame 46. In the example shown, outlet(s) 66 include one or more film cooling holes 102A, which are adapted to conduct a portion of frame cooling air from passage 90 (shown in FIG. 2C) to a periphery of strut 58. Cooling air exits cooling holes 102A and flows along or against one or more frame surfaces including circumferential strut walls 68. Circumferential strut walls 68 and other annular frame surfaces are heated due to the proximity of one or more fairings, such as outer fairing platform 60 and strut liner 64, which are exposed to working or combustion gases 34.

In FIG. 2B, film cooling holes 102A are formed through one or both circumferential strut walls 68, and have an exit portion directed toward strut forward end 106. Subsequent figures show other examples of outlets 66 with different film cooling hole configurations. For example, one or more film cooling holes can have exit portions extending normal to circumferential strut wall surface 104. Other film cooling holes can have exit portions directed toward strut aft end 108 (shown in FIG. 2C). One or more film cooling holes can also be angled radially inboard or outboard relative to engine center line 12 (shown in FIG. 1) to minimize flow separation of the exiting cooling air along strut wall surfaces 104.

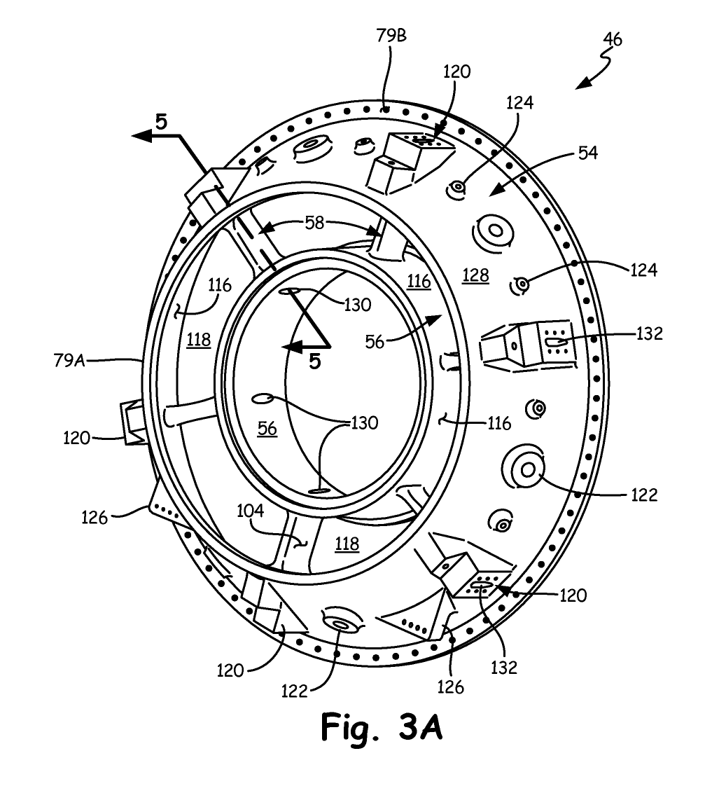

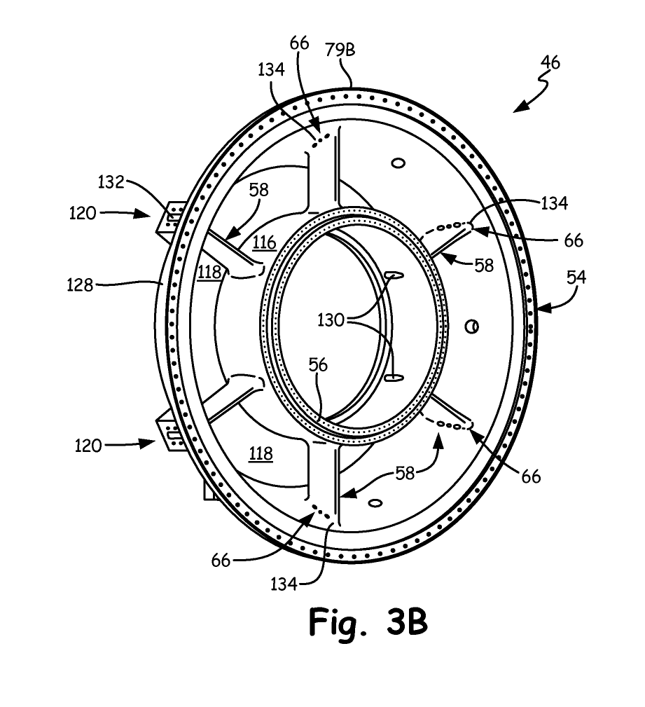

FIG. 2C shows radial passages 90 which provide fluid communication between one or more inlets (shown in FIG. 3B) and outlet(s) 66. In certain embodiments, cooling air can flow radially outward through passage 90 (defined by inner passage surface 110) from inner cavity 92 toward outer cavity 94 (shown in FIG. 2A). In certain embodiments, portions of inner passage surface 110 can be shaped to accommodate one or more service lines 112 (shown in phantom) while still maintaining sufficient radial coolant flow through passages 90. Cooling air can return toward inner hub 56 through fairing cavities 114A, 114B formed on either circumferential side of heat shield elements 84.

FIG. 3A isometrically depicts a forward side of frame 46, while FIG. 3B isometrically depicts an aft side of frame 46. Frame 46 includes a circumferentially distributed plurality of struts 58 extending radially between outer case 54 and inner hub 56. As seen in FIGS. 2A and 2B, fairing assembly 48 comprises a plurality of fairing elements disposed over and spaced apart from frame 46 to define main gas flow passage 51. FIG. 3A shows annular frame surfaces 116 over which the fairing segments may be secured. Annular surfaces 116 include the surfaces of frame 46 bounding annular frame cavity 118. These include platform surfaces of outer case 54 and inner hub 56, as well as outer surfaces of strut circumferential walls 68.

A number of mounting, operational, and inspection features such as outer case mounting flanges 79A, 79B, strut bosses 120, probe bosses 122, borescope bosses 124, and frame support stands 126, can be formed out of outer frame surface 128. These may be formed by a combination of casting, forging, and/or machining. Other features such as inner and outer strut ports 130, 132 can be machined respectively through inner hub 56 and outer case 54 to provide access to strut passages 90 (shown in FIGS. 2A and 2B). Cooling air outlets 66 are also machined through struts 58, outer frame junction 134, and/or inner frame junction 135.

In this example, passage inlets 130 are machined or otherwise formed through inner frame hub 58. Passage inlets 130 are circumferentially aligned with strut 58 and passage 90, and can include a cover plate or other device (not shown) operable to meter cooling air and/or retain any service lines (not shown) extending through passage 90. Alternatively, cooling air flow enters passage 90 from a separate inlet formed through inner hub 56 and which is circumferentially offset from passage 90. This alternative provides additional length through which the cooling air must travel, which can further reduce operating temperatures of inner hub 56.

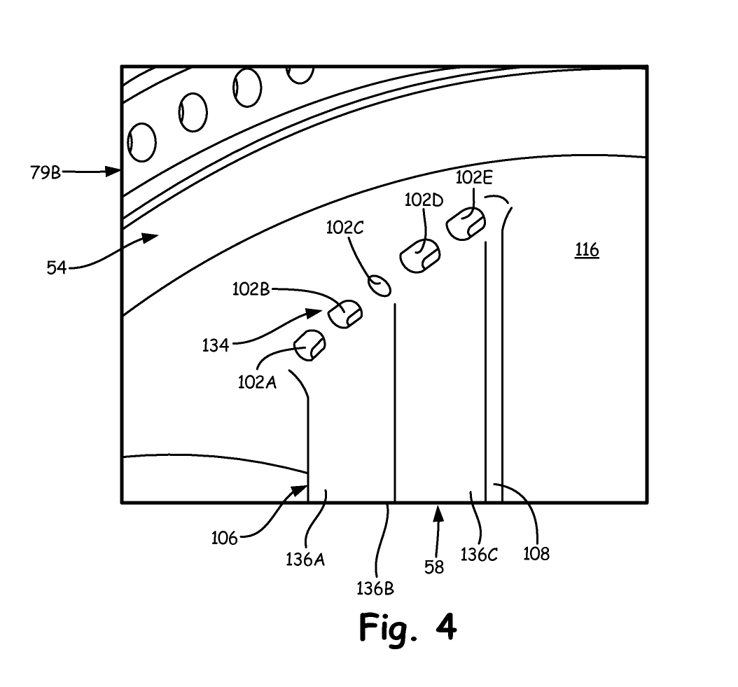

To facilitate use of lower temperature structural materials such as certain high-strength steel alloys, frame 46 can be provided with a cooling system comprising at least one cooling air passage 90 providing fluid communication through strut 58, between cooling air inlets 130 and cooling air outlets 66. In certain embodiments, each strut 58 includes one or more radially extending passages 90. Each outlet 66 can comprise a plurality of film cooling holes as shown in FIG. 4. Here, each strut 58 includes cooling air outlet 66 through both circumferential strut walls 68. Each cooling air outlet comprises three film cooling holes aligned in a showerhead configuration along each outer frame junction 134, proximate the intersections of outer case 54 and each strut 58.

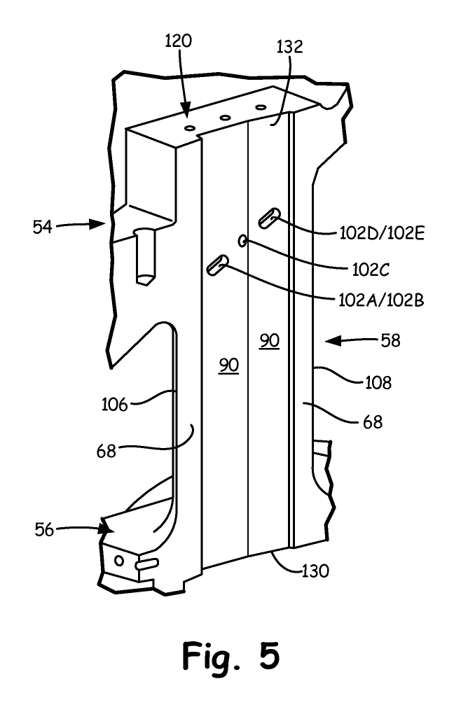

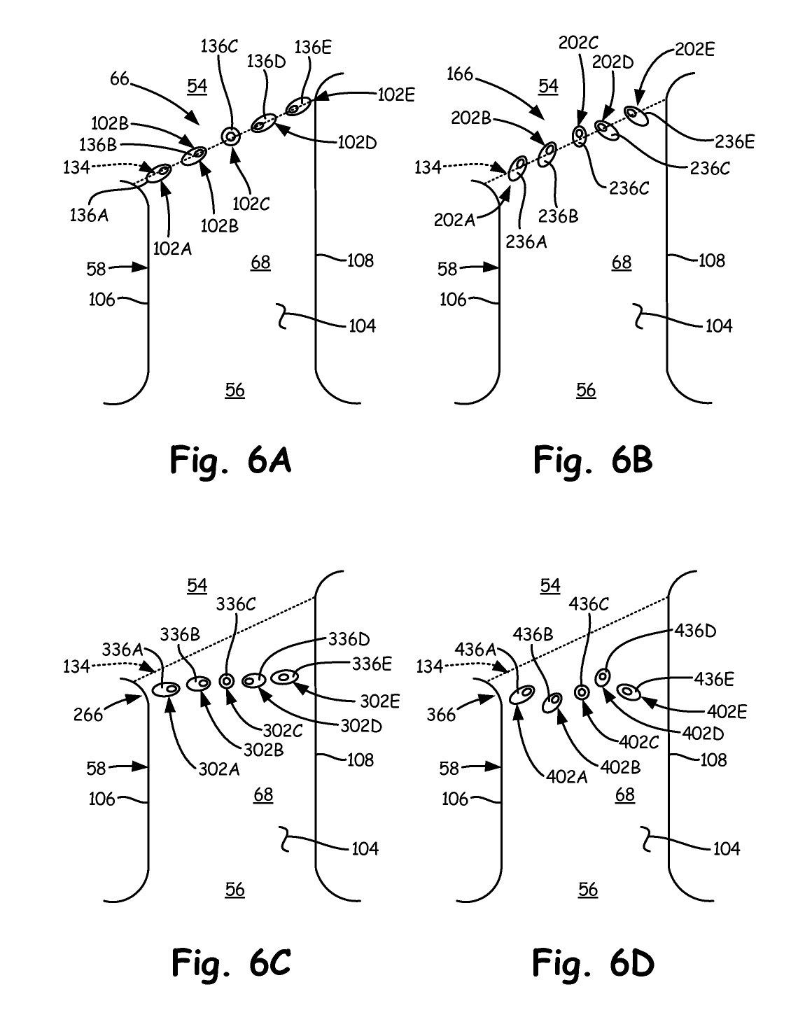

FIG. 4 is a detailed view of FIG. 3B, and shows film cooling holes 102A, 102B, 102C, 102D, 102E arranged linearly along outer frame junction 134. Here, film cooling holes 102A, 102B, 102C, 102D, 102E each have a substantially round cross-section and include respective exit portions 136A, 136B, 136C, 136D, 136E. Here, holes 102A, 102B intersect proximate passage 90. Similarly holes 102D, 102E intersect proximate passage 90. Exit portions 136A, 136B, 136C, 136D, 136E are arrayed in a showerhead orientation along outer frame junction 134 such that exiting cooling air contacts both outer frame 54 as well as strut wall surfaces 104. FIG. 5 shows this configuration in more detail, while FIGS. 6A-6D depict other example arrangements of film cooling holes disposed proximate outer frame junction 134.

FIG. 5 shows a radial cross-section of frame 46 taken across line 5-5 of FIG. 3A. FIG. 5 shows cooling air passages 90 extending radially through struts 58 between inner hub 56 and outer case 54. In certain embodiments of cast frame 46, passages 90 are machined radially through a previously solid strut 58. With increased radial casting dimensions, traditional milling equipment can generate excessive heat and is prone to misalignment due to the length of each strut 58. For example, in castings measuring at least about 1.5 meters (about 59 inches), each strut 58 typically has a radial dimension of at least about 0.5 meters (about 20 inches). Thus in certain embodiments, passages 90 are formed radially through solid struts using high-speed machining processes. These processes, sometimes known as “ballistic machining”, utilize specialized milling equipment to achieve high rotational tool speeds, along with cooling and chip removal features to precisely direct the tool through struts 58

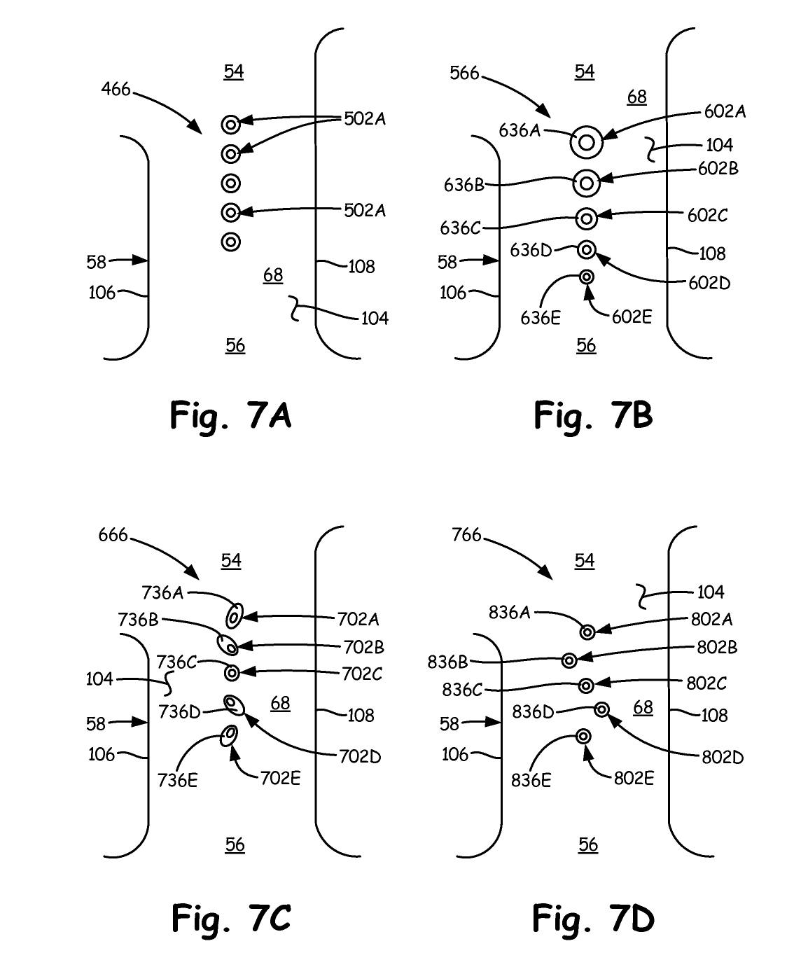

The number, shape, and configuration of outlets 66, passage(s) 90, and inlet(s) 130 can be selected to control or optimize the balance of cooling air between outer cooling air cavity 92 and inner cooling air cavity 94 (shown in FIG. 2A). To minimize thermal stresses on larger turbine engine frames 48, passages 90 are sized such that more than about 50% of the cooling air flow is directed toward outer case 54 and outer cavity 92, while the remainder is directed to inner hub 56 and inner cooling air cavity 94. The actual radial distribution of cooling air will vary depending on other factors such as secondary cooling air flow, material and structural properties of frame 46, and turbine operating temperature. For example, in high-strength steel alloy embodiments of frame 46, passages 90 are sized and shaped so that about 65% to about 75% of the cooling air flow is directed or retained around outer case 54, with the remainder directed or retained proximate inner hub 56. As will be seen in FIGS. 7A-7D, frame 46 can optionally or alternatively include one or more strut cooling holes disposed radially along circumferential strut walls 68 to further control cooling air balance between the outer and inner diameters of frame 46.

FIGS. 6A-6D depict various configurations of cooling air outlets located proximate outer frame junction 134. While FIGS. 6A-6D only show one circumferential face of strut 58, it will be recognized that one or both sides of strut 58 can include a cooling air outlet to effectively cool a corresponding region proximate one or both sides of outer frame junction 134.

FIG. 6A shows one example arrangement which was previously described with respect to FIGS. 2A-5. In this example, cooling holes 102A, 102B, 102C, 102D, 102E are aligned linearly along outer frame junction 134. Exit portions 136A, 136B, 136C, 136D, 136E are shaped and angled so as to follow the angle of outer case 54. Forward holes 102A, 102B include exit portions 136A, 136B directing exiting cooling air downward (radially inboard) and forward toward strut forward end 106. Middle hole 102C includes exit portion 136C directing exiting cooling air normal to circumferential strut wall 68. Aft holes 102D, 102E include exit portions 136D, 136E directing exiting cooling air upward (radially outboard) and aftward toward strut aft end 108. As noted above with respect to FIGS. 4 and 5, one or more cooling holes 102A, 102B, 102C, 102D, 102E can intersect within strut 58.

FIG. 6B shows a second cooling air outlet 166 including an arrangement of cooling holes 202A, 202B, 202C, 202D, 202E each with respective exit portions 236A, 236B, 236C, 236D, 236E. Here, holes 202A, 202B, 202C, 202D, 202E are also aligned along outer frame junction 134. However, exit portions 236A, 236B, 236C, 236D, 236E are all angled inboard to cool more of strut 58 as compared to inner case 54. In certain embodiments, cooling holes 202A, 202B, 202C are angled up to about 45° in the radial inboard direction. In addition, forward holes 202A, 202B direct exiting cooling air forward toward strut forward end 106, while aft holes 202D, 202E directs exiting cooling air aftward toward strut aft end 108. In certain of these embodiments, one or more exit portions 236A, 236B, 236C, 236D, 236E can be angled up to about 10° in a forward or aftward direction.

FIG. 6C shows a third cooling air outlet 266 including an arrangement of cooling holes 302A, 302B, 302C, 302D, 302E each with respective exit portions 336A, 336B, 336C, 336D, 336E. Here, holes 302A, 302B, 302C, 302D, 302E are disposed proximate outer frame junction 134. In contrast to FIGS. 6A and 6B, FIG. 6C shows an arrangement of film cooling holes 302A, 302B, 302C, 302D, 302E, which are aligned axially along a line parallel to engine center line 12 (shown in FIG. 1). Since the aft side holes are located apart from outer frame junction, one or more exit portions 336A, 336B, 336C, 336D, 336E can optionally be angled to direct cooling air in a radially outboard direction so as to provide sufficient cooling air to outer case 54. In certain embodiments, one or more exit portions 336A, 336B, 336C, 336D, 336E are angled up to about 45° in the radial outboard direction. In certain of these embodiments, one or more exit portions 336A, 336B, 336C, 336D, 336E can be angled up to about 10° in a forward or aftward direction.

FIG. 6D shows a fourth cooling air outlet 366 including an arrangement of cooling holes 402A, 402B, 402C, 402D, 402E each with respective exit portions 436A, 436B, 436C, 436D, 436E. Here, holes 402A, 402B, 402C, 402D, 402E are disposed proximate outer frame junction 134. In contrast to FIG. 6C, FIG. 6D shows an arrangement of film cooling holes 402A, 402B, 402C, 402D, 402E, which are axially staggered relative to a line parallel to engine center line 12 (shown in FIG. 1). Since the aft side holes are located apart from outer frame junction, one or more exit portions 436A, 436B, 436C, 436D, 436E can optionally be angled to direct cooling air in a radially outboard direction so as to provide sufficient cooling air to outer case 54. Similar to FIGS. 6A-6C, one or more exit portions 436A, 436B, 436C, 436D, 436E can be angled up to about 10° in a forward or aftward direction.

As described with respect to FIGS. 2A, 4 and 5, passages 90 can be sized to control the balance of cooling air between inner and outer portions of frame 46. FIGS. 7A-7D can also show different configurations of cooling air outlets used to help achieve a desired balance by more efficiently using higher pressure and lower temperature cooling air on the inboard portion of the frame while providing a higher flow rate to outer portions of the frame. One or more of these film cooling holes described in FIGS. 7A-7D can be formed through each strut at a location distal from the inner and outer frame junctions.

FIG. 7A shows a fifth example outlet 466 with a radial arrangement of five cooling holes 502. Cooling holes 502 with exit portions 536 are aligned linearly along strut 58. Alternatively, cooling holes 502 can be aligned into multiple lines along strut 58. Exit portions 536 are shaped and angled so as to direct cooling air normal to circumferential strut wall 68. In this example, holes 502 are round and all have substantially the same cross-sectional area.

FIG. 7B shows a sixth example outlet 566 with a radial arrangement of five cooling holes 602A, 602B, 602C, 602D, 602E. Cooling holes 602A, 602B, 602C, 602D, 602E with exit portions 636A, 636B, 636C, 636D, 636E are aligned linearly along strut 58. Exit portions 536 are shaped and angled so as to direct cooling air normal to circumferential strut wall 68. In this example, holes 602A, 602B, 602C, 602D, 602E are round and all have different cross-sectional areas. First hole 602A is closest to outer case 54, and has the largest cross-sectional area, while fifth hole 602E is closest to inner hub 56 and has the smallest cross-sectional area. This can be done in conjunction with embodiments of TEC assembly 42 (see, e.g., FIG. 2A) to substantially equalize cooling air effectiveness along the length of strut 58. In the configuration of FIG. 2A, cooling air experiences a pressure drop and a temperature increase as it travels radially outward through passage 90 from inner cooling air cavity 92 toward outer cooling air cavity 94. As such, fifth hole 602E closest to inner hub 56 has the highest supply pressure, while first hole 602A farthest from inner hub 56 has the lowest supply pressure with intermediate supply pressures provided to holes 602B, 602C, and 602D.

In certain alternative embodiments, one or more cooling hole exit portions 636A, 636B, 636C, 636D, 636E are angled to direct exiting cooling air upward (radially outboard) directly toward frame outer case 54. In certain of these embodiments, a majority of strut cooling holes can be directed radially outboard to help achieve a balance of more than 50% of the cooling air reaching the outer portions of struts 58 and/or outer case 54. The remainder can be disposed normally or radially inboard. Additionally or alternatively, one or more cooling hole exit portions 636A, 636B, 636C, 636D, 636E can be angled to direct exiting cooling air up to about 10° in a forward and/or aftward direction.

FIG. 7C shows a seventh example outlet 666 with a radial arrangement of five cooling holes 702A, 702B, 702C, 702D, 702E with respective exit portions 736A, 736B, 736C, 736D, 736E. Similar to FIG. 7A, cooling holes 702A, 702B, 702C, 702D, 702E are aligned linearly along strut 58. However, one or more cooling hole exit portions 736A, 736B, 736C, 736D, 736E are angled to direct exiting cooling air upward (radially outboard) directly toward frame outer case 54. Additionally or alternatively, one or more cooling hole exit portions 736A, 736B, 736C, 736D, 736E can be angled to direct exiting cooling air up to about 10° in a forward and/or aftward direction.

FIG. 7D shows an eighth cooling air outlet 766 including an arrangement of cooling holes 802A, 802B, 802C, 802D, 802E each with respective exit portions 836A, 836B, 836C, 836D, 836E. Here, holes 802A, 802B, 802C, 802D, 802E are disposed along strut 58. In contrast to FIGS. 7A-7C, however, FIG. 7D shows film cooling holes 802A, 802B, 802C, 802D, 802E, which are radially staggered relative to strut 58. Similar to FIGS. 7A-7C, one or more exit portions 836A, 836B, 836C, 836D, 836E can be angled to direct exiting cooling air upward (radially outboard) directly toward frame outer case 54. Additionally or alternatively, one or more cooling hole exit portions 836A, 836B, 836C, 836D, 836E can be angled to direct exiting cooling air up to about 10° in a forward and/or aftward direction.

Similar to the junction cooling holes (see, e.g., FIGS. 4 and 5), the outlets through circumferential strut wall 68 can comprise a first film cooling hole intersecting a second film cooling hole in wall 68.

Radially arranged cooling air outlets, such as those shown in FIGS. 7A-7D can allow for possible reduction of parts both in circulation through the secondary air system, as well as in regards to sealing. Cooler air can be passed to the surrounding modules (e.g. upstream module 44 and downstream module 45 shown in FIG. 2A as compared to other configurations, and thus can increase overall engine efficiency by requiring less cooling air to be pulled from the compressor. In addition, radially arranged cooling air outlets could simplify manufacturing of frame 46 (shown in FIGS. 3A and 3B) due to the possibility of smaller cooling passages 90 and the easily accessible strut walls 68.

In certain embodiments, a frame can include both strut (radial) cooling holes as well as junction cooling holes. For example, strut cooling holes may be sufficient to provide a suitable balance of cooling air between the inner and outer frame sections. However, supplemental cooling around the outer frame junction may also be provided via one or more junction cooling holes to address localized thermal or mechanical requirements. In other embodiments, outer junction cooling holes and passages may be generally sufficient to cool the region proximate the outer frame junction, but one or more strut cooling holes can be added to supplement flow balancing needs and/or provide localized cooling in and around the length of the strut.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A module for a gas turbine engine comprising:
a frame including a circumferentially distributed plurality of radially extending struts, each strut joined to an outer frame section at an outer frame junction, and joined to an inner frame section at an inner frame junction; and
a frame cooling system comprising:
an inlet;
a cooling air passage extending from the inlet radially through one of the plurality of frame struts; and
an outlet in fluid communication with the cooling air passage, the outlet including a plurality of film cooling holes formed through a circumferentially facing wall of each strut at a location distal from the outer frame junction.

2. The module of claim 1, further comprising:
a fairing assembly disposed over and spaced apart from a plurality of annular frame surfaces.

3. The module of claim 2, wherein the fairing assembly includes a strut liner disposed over and spaced apart from at least one of the film cooling holes, the at least one film cooling hole including an exit portion angled to direct a volume of cooling air from the cooling air passage into at least one fairing cavity defined between the strut liner and the annular strut surface.

4. The module of claim 1, wherein a first one of the plurality of film cooling holes comprises an exit portion angled radially outboard along the circumferentially facing strut wall.

5. The module of claim 1, wherein a first one of the plurality of film cooling holes comprises an exit portion angled radially inboard along the circumferentially facing strut wall.

6. The module of claim 1, wherein the plurality of film cooling holes are aligned linearly along the circumferentially facing wall of each strut.

7. The module of claim 1, wherein the frame cooling system includes a plurality of cooling air inlets providing fluid communication between each cooling air passage and an inner cooling air cavity disposed radially inward of the inner frame section, each inlet circumferentially aligned relative to each cooling air passage.

8. The module of claim 1, further comprising:
a first turbine section operable to rotate a first shaft;
a second turbine section operable to rotate a second shaft independent of the first shaft;
wherein the outer frame section interconnects an outer case of the first turbine section with an outer case of the second turbine section.

9. The module of claim 1, wherein the module comprises a turbine exhaust case assembly.

10. The module of claim 9, wherein the turbine exhaust case assembly is adapted to interconnect a low-pressure turbine assembly with a power turbine assembly.

11. The module of claim 9, wherein the turbine exhaust case assembly further comprises:
a heat shield assembly including at least one heat shield element with a reflective portion disposed within at least one fairing cavity defined between a strut liner and an annular strut surface, the reflective portion adapted to block a line of sight between the strut liner and the annular frame surface.

12. The module of claim 1, wherein the frame cooling system comprises at least one cooling air passage extending radially through each of the plurality of circumferentially distributed struts.

13. A gas turbine engine frame comprising:
an outer case;
an inner hub adapted to support a first shaft of the gas turbine engine;
a strut extending radially between the inner hub and the outer case; and
a cooling system including an inlet formed through the inner hub, a cooling air passage extending from the inlet radially through the struts, and an outlet including a film cooling hole formed through a circumferentially facing wall of the strut at a location distal from a junction of the strut and the outer case.

14. The frame of claim 13, wherein the film cooling hole comprises an exit portion angled extending normal to the circumferentially facing strut wall.

15. The frame of claim 13, wherein the film cooling hole comprises an exit portion angled in a radial outboard direction relative to the circumferentially facing strut wall.

16. The frame of claim 13, wherein the film cooling hole comprises an exit portion angled a radial inboard direction relative to the circumferentially facing strut wall.

17. The frame of claim 13, wherein the film cooling hole comprises an exit portion angled in an axial forward direction relative to the circumferentially facing strut wall.

18. The frame of claim 13, wherein the film cooling hole comprises an exit portion angled in an axial aft direction relative to the circumferentially facing strut wall.

19. The frame of claim 13, wherein the outlet comprises a plurality of cooling holes arranged into a line generally parallel to the strut.

20. The frame of claim 19, wherein the plurality of cooling holes are arranged into a plurality of lines generally parallel to the strut.

21. The frame of claim 19, wherein a first cooling hole has a first exit diameter, and a second cooling hole has a second exit diameter, the second cooling hole disposed aft of the first cooling hole, and the second diameter larger than the first diameter.

22. The frame of claim 13, wherein the outlet comprises a plurality of radially staggered cooling holes formed through the circumferentially facing strut wall.

23. The frame of claim 13, wherein the outlet comprises a first film cooling hole intersecting with a second cooling hole in the circumferentially facing strut wall.
